(19) United States
(12) Patent Application Publication
(10) Pub. No.: US 2024/0002261 A1
(43) Pub. Date: Jan. 4, 2024

(54) MATERIALS AND METHODS FOR WATER PURIFICATION

(71) Applicants: UNIVERSITY OF IOWA RESEARCH FOUNDATION, lowa City, IA (US); UNIVERSITY OF NOTRE DAME DU LAC, South Bend, IN (US)

(72) Inventors: David M. CWIERTNY, Iowa City, IA (US); Nosang V. MYUNG, South Bend, IN (US); Sewoon KIM, Iowa City, IA (US)

(73) Assignee: UNIVERSITY OF IOWA RESEARCH FOUNDATION, Iowa City, IA (US)

(21) Appl. No.: 18/215,463

(22) Filed: Jun. 28, 2023

Related U.S. Application Data
(60) Provisional application No. 63/356,683, filed on Jun. 29, 2022.
(60) Provisional application No. 63/523,559, filed on Jun. 27, 2023.

(51) Int. Cl. C02F 1/28

(52) U.S. Cl. CPC C02F 1/288; C02F 2101/20

(57) ABSTRACT

The invention provides a method and materials for removing a metal contaminant from a water sample, as well as composites and methods for making composites.

### PRIORITY

This application claims priority to U.S. Provisional Patent Application No. 63/356,683, filed 29 Jun. 2022 and to U.S. Provisional Patent Application No. 63/523,559, filed 27 Jun. 2023. The entire content of each of these United States Provisional Patent Applications is hereby incorporated by reference herein.

### STATEMENT REGARDING FEDERALLY SPONSORED RESEARCH

This invention was made with government support under 1940777, 202909, and 2232527 awarded by the National Science Foundation. The government has certain rights in the invention.

### BACKGROUND

Currently there is a need for materials and methods that can be used to remove contaminants, such as metals (e.g. uranium, lead, or copper) from water.

### SUMMARY

This invention involves the production and use of novel sorbent materials (e.g., produced by electrospinning) in water treatment. Through the integration of simple organic acids, polymer nanofibers and their composites with metal oxides become high-capacity sorbent materials for removal of metal contaminants (e.g., positively charged metal ions like lead, uranium, or copper) commonly found in drinking water. These materials are especially useful in point-of-use and point-of-entry water treatment systems, which are commonly relied upon by consumers to remove metal contaminants from their drinking water.

Phthalic acid (hereafter referred to as PTA) and other organic carboxylic acids can be added to electrospun polymers and polymer-metal oxide nanoparticle composites to enhance their performance as sorbents for use in water treatment to remove metal contaminants. PTA is a dicarboxylic aromatic acid that can be easily blended into sol gel solutions used to produce polymers and polymer-metal oxide nanoparticle composites via electrospinning. In one embodiment, the invention provides electrospun polymers of polyacrylonitrile (PAN) or nylon, as well composites of these polymers produced with several different types of metal oxides including oxides of iron (hematite; Fe₂O₃), titanium (TiO₂), manganese (MnO₂), cobalt (Co₃O₄), zinc (ZnO), and mixtures thereof. The improved reactivity attributable to inclusion of PTA can also be achieved using structurally related carboxylic acids (e.g., aromatic carboxylic acids, including terephthalic acid and other structurally related congeners).

The resulting nanofibers produced from these sol gels containing PTA have been tested for their ability to removal common metal contaminants from drinking water, with a focus on uranium and lead. For uranium removal, it was found that all materials prepared with PTA (at ˜3 wt. % relative to the total mass of the initial sol gel solution) outperformed their analogs without PTA, sometimes by more than 2-fold. This was also the case for lead uptake, where PTA-containing PAN-iron oxide composites were able to increase lead uptake by almost 4-fold relative to PAN-iron oxide composites without PTA. Moreover, it was found that the amount of PTA (up to 5 wt. % relative to the total mass of the initial sol gel) influenced lead uptake, with the amount of lead sorbed to these materials generally increasing with PTA content. As a final important point, PTA was well retained within these PAN-iron oxide composites; thorough washing of the materials with water prior to reactivity testing (to release any loosely bound PTA) had no influence on the degree of lead uptake relative to PTA-containing materials that were not extensively washed prior to use. Thus, PTA was well retained within the polymer, and this performance will likely be sustained during the long-term use of these materials in water treatment.

The unique and unexpected increase in sorbent capacity from the inclusion of PTA can be attributed to at least two things. First, the ability of PTA to produce surface sites on the composite surface that promote metal (e.g., uranium and lead) uptake. At pH values relevant to drinking water treatment, both carboxylic acid groups on PTA are deprotonated. Thus, once retained within the polymer framework, it introduces anionic (negatively charged) sites that are ideal for attracting cationic (positively charged) water contaminants, which include many types of metal contaminants. For example, the dominant forms of lead (Pb²⁺) and uranium (uranyl ion; UO₂²⁺) are both positively charged in drinking water, and therefore, ideally suited for removal by anionic surface sites on the polymer-composite surface when PTA is present. Second, PTA acts as a dispersant of nanoparticles in electrospinning sol gels. With a dispersant, metal oxide nanoparticles are better suspended in electrospinning sol gels. Through subsequent surface segregation, PTA assists these metal oxides in preferentially migrating to and concentrating on the surface of the polymer nanofiber during the electrospinning process. Thus, PTA also improves composite performance by producing a better distribution and more uniform availability of metal oxide, which are also good sorbents for lead and uranium, on the composite surface. These two mechanisms of enhancement likely work in tandem, producing uptake behavior for metal contaminants that cannot be explained by either mechanism alone.

In one aspect the present invention provides a method for removing a metal contaminant from a water sample comprising, contacting a water sample that comprises a metal contaminant with a sorbent that comprises a carboxylic acid, under conditions where the metal contaminant is removed from the water sample.

In another aspect, the invention provides a filtration system for removing a metal contaminant from a water sample comprising, a non-woven nanofiber sorbent that comprises a carboxylic acid.

In another aspect, the invention provides a composite, comprising, polymeric nanofibers; metal oxide nanoparticles; and a carboxylic acid.

In another aspect, the invention provides a non-woven mat comprising a composite of the invention.

In another aspect, the invention provides a point-of-use filtration device comprising a non-woven mat of the invention.

In another aspect, the invention provides a method comprising, providing a non-woven mat of the invention; and contacting a water sample that comprises a metal contaminant with the mat.

In another aspect, the invention provides a method comprising: electrospinning a mixture comprising a carbon source (e.g. PAN), an iron oxide, a poly-carboxylic acid, and a solvent to provide a composite.

The invention also provides processes and intermediates disclosed herein that are useful for preparing the sorbents described herein.

### BRIEF DESCRIPTION OF THE FIGURES

FIG. 1 shows data from Example 1.

FIG. 2 shows uptake isotherms for lead by nanofiber composites with different organic acid additives including PTA, TPA, and EDTA. All formulations contain the same wt. % of organic acid additive, and data were collected with PAN-based composites. Data are shown for both as fabricated (“unwashed”) and materials after extensive washing (“washed”) to ensure the retention of additives during use. Experimental conditions: Cᵢₙᵢₜᵢₐₗ=1, 5, 10, 15, 20, and 40 mg/L as Pb; pH=6.5 (buffered by 10 mM HEPES), T=20° C.; dosage=0.5 g/L; contact time=over 24 h.

FIG. 3 shows uptake isotherms for lead by Nylon-based nanofiber composites with different additives including phthalic acid (PTA) and the anionic surfactant sodium dodecyl sulfate (SDS). Data are shown for both as fabricated (“unwashed”) and materials after extensive washing (“washed”) to ensure the retention of additives during use. Experimental conditions: Cᵢₙᵢₜᵢₐₗ=1, 5, 10, 15, 20, and 40 mg/L as Pb; pH=6.5 (buffered by 10 mM HEPES), T=20° C.; dosage=0.5 g/L; contact time=over 24 h.

FIG. 4 shows removal of lead from water via dead-end filtration with PTA-functionalized, Nylon-based iron oxide nanofiber composite. Data shows the lead concentration in the effluent (after filtration) normalized to the lead concentration in the influent. Breakthrough is observed after about 10 L of lead-containing water (150 ppb or mg/L) had been passed through the filter. Experimental conditions: Filter mass ˜300 mg, Influent Pb Conc.=150 ppb, Flow rate=20 mL/min (for flux of 952.4 LMH), Effective nanofiber area=12.6 cm², and pH 6.5 with 10 mM HEPES buffer.

FIG. 5 shows an illustration of a non-woven nanofiber sorbent that includes a carboxylic acid in accordance with some embodiments of the present disclosure.

FIG. 6 shows an illustration of a composite including polymeric nanofibers, metal oxide nanoparticles, and a carboxylic acid in accordance with some embodiments of the present disclosure.

FIG. 7 shows an illustration of a non-woven mat including a composite in accordance with some embodiments of the present disclosure.

FIG. 8 shows an illustration of a point-of-use filtration device including a non-woven mat in accordance with some embodiments of the present disclosure.

### DETAILED DESCRIPTION

There are several advantages of PTA-containing materials. First, they produce a high-capacity sorbent for positively charged ions (e.g., lead, uranium, and copper) that exceed many other sorbent materials. For example, good commercially available sorbents for lead remove anywhere from 10-100 mg of lead per gram of sorbent material. The PTA-containing iron-oxide composites of the invention remove about 50 mg of lead per gram, making them competitive with other commercial lead sorbents, which are in growing demand. Second, other anionic additives for polymers have been explored to potentially increase cationic metal uptake. However, prior to PTA, all other anionic additives were poorly retained within the polymer over time, leading to significant losses in material performance during use. PTA-containing materials are superior, therefore, as the PTA is well-retained within the materials, and the materials suffer from no loss in water treatment performance over operation time. Third, these organic acids are also lower in cost than other anionic additives that have previously been explored (e.g., anionic surfactants) to date. Thus, the identification of PTA (and other organic carboxylic acids) as an additive to promote metal uptake represent an important advance in technology development that both improves material performance while lowering production costs and not increasing the complexity of synthesis.

The composites of the invention can be prepared by techniques that are known. For example, the electro-spun composites described herein can be prepared using processes similar to those described in U.S. Pat. No. 11,136,453.

The term “metal oxide” includes any oxide of a metal that can be incorporated into a sorbent material to provide a material that can be used to remove a contaminant from a water sample. In one embodiment, the metal oxide comprises an oxide of iron, titanium, manganese, cobalt, or zinc. In one embodiment, the metal oxide comprises Fe₂O₃, TiO₂, MnO₂, Co₃O₄, or ZnO. In one embodiment, the metal oxide comprises Fe₂O₃. In one embodiment, the metal oxide is Fe₂O₃.

The term “carboxylic acid” includes molecules that comprise one or more carboxy (—COOH) groups. In one embodiment, the term includes linear and branched carboxylic acids (e.g., linear and branched carboxylic acids having from 1-20 carbon atoms). In one embodiment, the term includes linear and branched poly-carboxylic acids (e.g., linear and branched carboxylic acids having from 1-20 carbon atoms and 2 or more carboxy groups, such as, for example, ethylenediaminetetraacetic acid). In one embodiment, the term includes an aromatic carboxylic acid. In one embodiment, the term includes an aromatic poly-carboxylic acid. In one embodiment, the term includes a phenyl carboxylic acid or a naphthyl carboxylic acid. In one embodiment, the term includes a phenyl poly-carboxylic acid or a naphthyl poly-carboxylic acid. In one embodiment, the carboxylic acid is phthalic acid.

The term “metal contaminant” includes any unwanted contaminant in a water sample that comprises a metal. In one embodiment, the metal contaminant comprises a positively charged metal ion. In one embodiment, the metal contaminant comprises a uranium ion, lead ion, or copper ion.

The term “sorbent” includes any material that comprises an organic polymer and a carboxylic acid and that can be used to remove a contaminant from a water sample. In one embodiment, the sorbent comprises a non-woven nanofiber. In one embodiment, the sorbent comprises a non-woven nanofiber that comprises an organic polymer. In one embodiment, the sorbent comprises polyacrylonitrile or a nylon. In one embodiment, the sorbent is preparable by electrospinning.

Electrospinning can be carried out in the presence of any suitable solvent. In one embodiment, the solvent is a polar solvent. In one embodiment, the solvent is a non-aqueous polar solvent. In one embodiment, the solvent comprises DMF (Dimethylformamide) HFIP (Hexafluoro-2-propanol) a formic acid or a C₁-C₆ alcohol. In one embodiment, the solvent comprises DMF (Dimethylformamide) HFIP (Hexafluoro-2-propanol) formic acid or ethyl alcohol. In one embodiment, the solvent is DMF (Dimethylformamide) HFIP (Hexafluoro-2-propanol) formic acid or ethyl alcohol. In one embodiment, the solvent comprises DMF. In one embodiment, the solvent is DMF. In one embodiment, for the preparation of nylon fibers, the solvent comprises HFIP. In one embodiment, for the preparation of nylon fibers, the solvent is HFIP.

The methods of the invention can be used to remove contaminants from water samples at any suitable pH. In one embodiment, the pH of the water sample is less than about 9.5. In one embodiment, the pH of the water sample is greater than about 6.

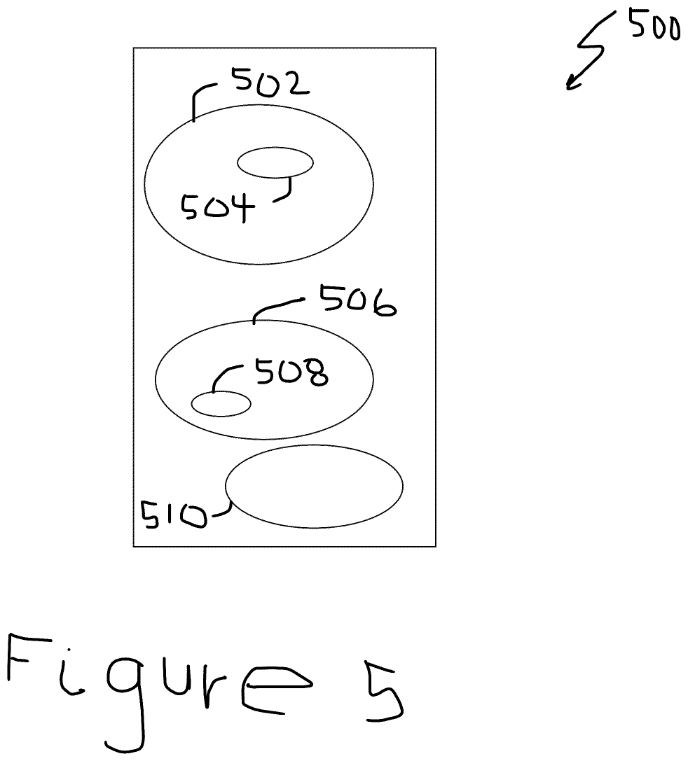

FIG. 5 shows an illustration of a non-woven nanofiber sorbent 500 that includes a carboxylic acid 502 in accordance with some embodiments of the present disclosure. In some embodiments, the carboxylic acid 502 includes phthalic acid 504. In some embodiments, the non-woven nanofiber sorbent 500 includes a metal oxide 506. In some embodiments, the metal oxide 506 includes Fe₂O₃, TiO₂, MnO₂, Co₃O₄, or ZnO₂ 508. In some embodiments, the non-woven nanofiber sorbent 500 includes an organic polymer 510.

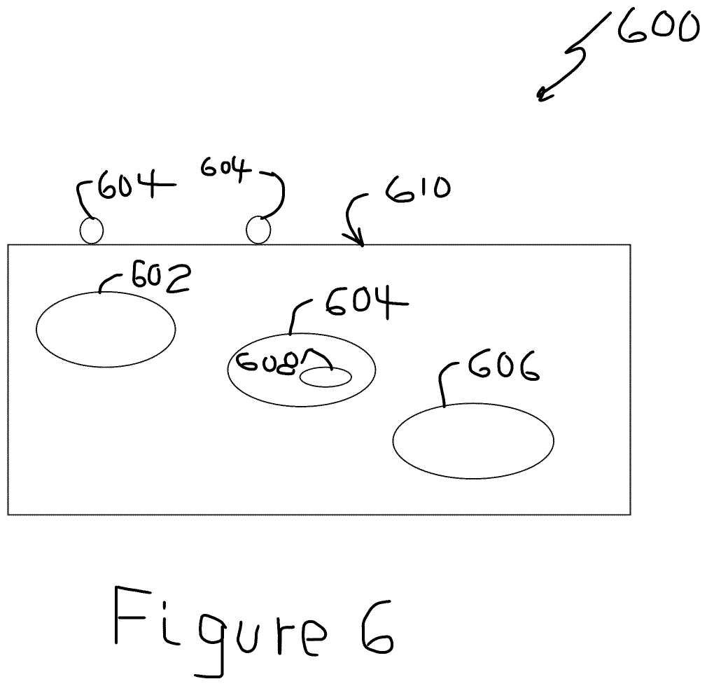

FIG. 6 shows an illustration of a side view of a composite 600 including polymeric nanofibers 602, metal oxide nanoparticles 604, and a carboxylic acid 606 in accordance with some embodiments of the present disclosure. In some embodiments, the metal oxide nanoparticles 604 include Fe₂O₃, TiO₂, MnO₂, Co₃O₄, or ZnO₂ 608 and the metal oxide nanoparticles 604 are preferentially dispersed or segregated on a surface 610 of the composite.

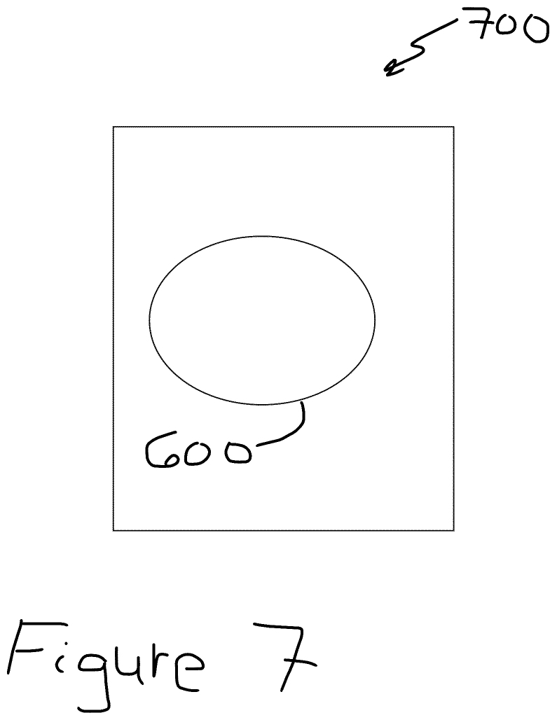

FIG. 7 shows an illustration of a non-woven mat 700 including a composite 600 in accordance with some embodiments of the present disclosure.

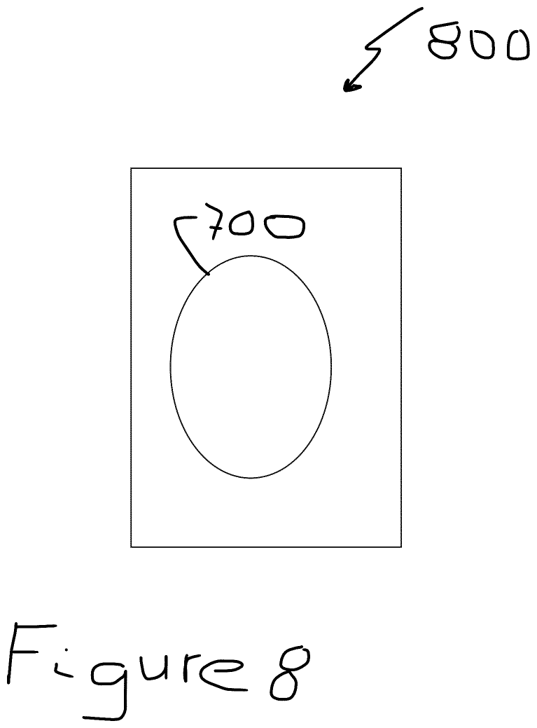

FIG. 8 shows an illustration of a point-of-use filtration device 800 including a non-woven mat 700 in accordance with some embodiments of the present disclosure.

The invention will now be illustrated by the following non-limiting Examples.

### EXAMPLES

### Example 1

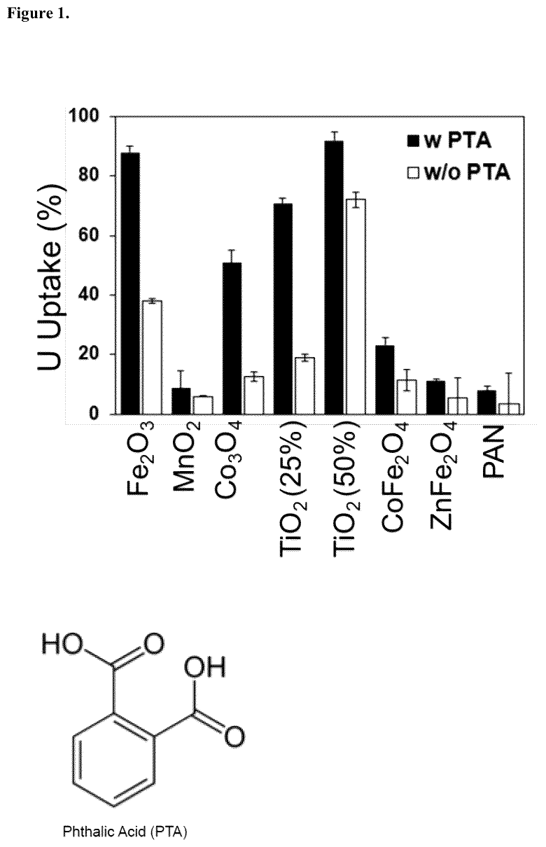

Equilibrium uptake of U on several different metal oxide-PAN composites is shown in FIG. 1. Data are shown for materials prepared at 25 wt % mass loading in the fiber (relative to PAN mass in the sol gel/˜4 wt % relative to sol gel mass) unless otherwise noted. Results for composites both with and without included PTA (at 3 wt % relative to sol gel mass) are provided. In all cases, the inclusion of PTA improved uptake of U. Experimental conditions: pH 6.5, 1 mM initial U.

### Example 2

Inclusion of organic acids increases the sorption performance of electrospun iron oxide-polymer composites. Functionalized polymer nanofibers were fabricated using various carboxylic acid-containing ligands. Phthalic acid (PTA), a benzenedicarboxylic acid consisting of two carboxyl groups at ortho positions was found to promote lead uptake in iron oxide nanoparticle composites prepared from polyacrylonitrile (PAN). This influence of PTA was attributed to its ability to stabilize the iron oxides in the electrospinning sol gel so as to promote nanoparticle dispersion and to the ability of residual PTA in the nanofiber composite to directly bind lead through its dicarboxylate ligands. Characterization has also shown that some PTA is released from the nanofiber composite after synthesis, generating pores that increase the surface area of the fibers available for lead uptake.

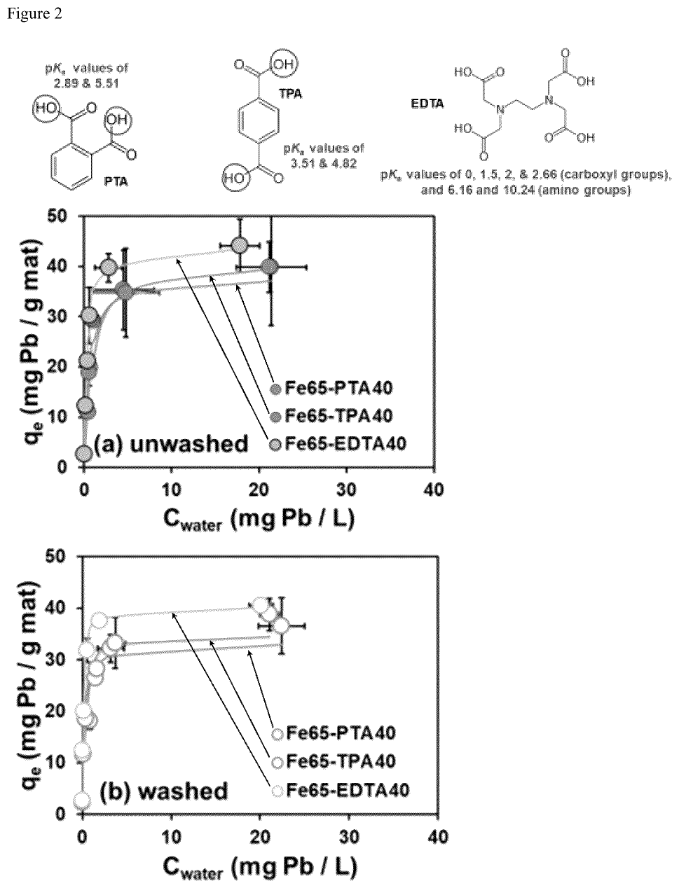

The ability of other carboxylated ligands, particularly those structurally related to PTA (e.g., meta- and para-substituted aromatic isomers) and higher-order polycarboxylates (e.g., EDTA), to exhibit similar or perhaps even greater, influence on lead uptake was explored. Functionalized fibers with terephthalic acid (para-substituted dicarboxylate) and isophthalic acid (meta-substituted dicarboxylate), as well as EDTA were prepared. All carboxylated ligands were blended into an electrospinning sol get at the same wt % loading (40% relative to PAN). Results of lead uptake studies from equilibrium sorption isotherms are show in FIG. 2. While modest differences in uptake were observed across these materials, all exhibited comparable performance to PTA-modified materials. Notably, the lead sorption capacity observed for all materials (on the order of 40 mg of Pb per g of sorbent) compares well to commercially available lead sorbents used in water treatment (with capacities typically between 10 and 100 mg of Pb per g of sorbent).

Unique reactivity of organic acid functionalized composites is observed for polymers other than PAN. Although widely used in electrospinning research, composites generated from PAN tended to be brittle and prone to breaking, particularly as fabrication recipes were increased to the scale necessary for prototype filter production. PAN is also relatively expensive as a polymer, and its use would considerably increase the unit production cost for our point-of-use filter devices. As such, the fabrication of functionalized iron oxide composites produced with other polymers that are more robust and economical was investigated.

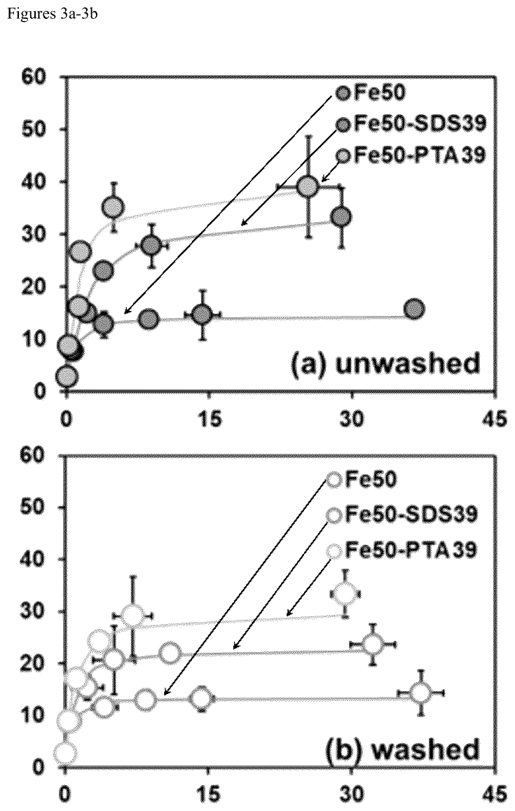

Composites of Nylon (using Nylon-66 as a precursor) that exhibit comparable reactivity to the PAN-based nanofiber composites we have previously investigated (see FIG. 3) were successfully prepared. These Nylon-based composites exhibit comparable capacity for lead uptake to that previously reported for PAN (˜30-40 mg of Pb per gram of nanofiber composite) based on lead sorption isotherm results. Moreover, additives including PTA and the anionic surfactant sodium dodecyl sulfate (SDS) seem reasonably well-retained in the Nylon polymer matric, with lead uptake performance remaining mostly unchanged between materials used immediately after fabrication (FIG. 3a) and those extensively rinsed with water prior to sorption experiments (a procedure previously used to remove any loosely held additives in electrospun nanofibers) (FIG. 3b).

Composites having the following components were prepared.

| | Wt. % (relative to Fe + Additives + Polymer) | | |
|---|---|---|---|
| | Fe | PTA or SDS | PAN or Nylon |
| Fe-PTA-PAN | 32.26 | 48.39 | 19.35 |
| Fe-PTA-Nylon | 26.44 | 20.65 | 52.91 |
| Fe-SDS-PAN | 32.26 | 48.39 | 19.35 |
| Fe-SDS-Nylon | 26.46 | 20.63 | 52.90 |

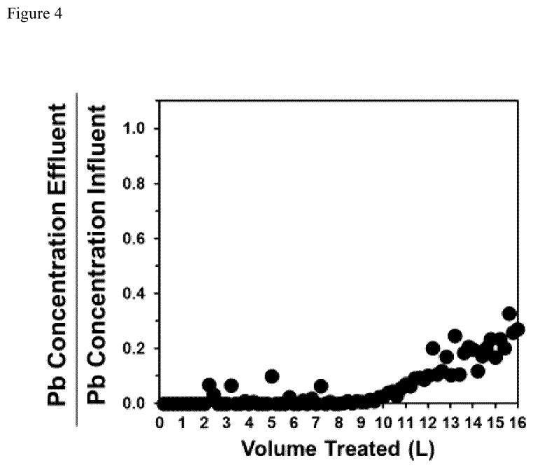

Long-term dead-end filtration trials were also conducted with the materials (FIG. 4), revealing their ability to remove nearly all of the lead (at an influent concentration of 150 mg/L or ppb) from ˜10 L of water; notably, using only 0.3 g of our PTA-containing iron oxide-nylon composite to treat this volume of water at a flux that is typical of that encountered in POU treatment devices. With this level of performance, only a few grams of the nylon-based filter would be required to treat an individual's drinking water supply (contaminated with 150 mg/L of dissolved lead, or 10-times the EPA's current action level) for one year.

All publications, patents, and patent documents (including U.S. Pat. No. 11,136,453) are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method for removing a metal contaminant from a water sample comprising, contacting a water sample that comprises a metal contaminant with a sorbent that comprises a carboxylic acid, under conditions where the metal contaminant is removed from the water sample.

2. The method of claim 1, wherein the metal contaminant is a uranium ion, lead ion, or copper ion.

3. The method of claim 1, wherein the sorbent comprises a non-woven nanofiber that comprises a metal oxide.

4. The method of claim 1, wherein the sorbent comprises a non-woven nanofiber that comprises Fe₂O₃, TiO₂, MnO₂, Co₃O₄, or ZnO.

5. The method of claim 1, wherein the sorbent comprises Fe₂O₃.

6. The method of claim 1, wherein the sorbent comprises a non-woven nanofiber that comprises an organic polymer.

7. The method of claim 1, wherein the carboxylic acid comprises an aromatic carboxylic acid

8. The method of claim 1, wherein the aromatic carboxylic acid comprises phthalic acid.

9. A filtration system for removing a metal contaminant from a water sample comprising, a non-woven nanofiber sorbent that comprises a carboxylic acid.

10. The filtration system of claim 9, wherein the non-woven nanofiber sorbent comprises a metal oxide.

11. The filtration system of claim 9, wherein the non-woven nanofiber sorbent comprises Fe₂O₃, TiO₂, MnO₂, Co₃O₄, or ZnO.

12. The filtration system of claim 9, wherein the non-woven nanofiber sorbent comprises Fe₂O₃.

13. The filtration system of claim 9, wherein the non-woven nanofiber sorbent comprises an organic polymer.

14. The filtration system of claim 9, wherein the carboxylic acid comprises phthalic acid.

15. A composite, comprising,
polymeric nanofibers;
metal oxide nanoparticles; and
a carboxylic acid.

16. The composite of claim 15, wherein the metal oxide nanoparticles comprise Fe₂O₃, TiO₂, MnO₂, Co₃O₄, or ZnO and wherein the metal oxide nanoparticles are preferentially dispersed or segregated on a surface of the composite.

17. A non-woven mat comprising the composite of claim 15.

18. A point-of-use filtration device comprising the non-woven mat of claim 17.

19. A method comprising, providing a non-woven mat of claim 17; and contacting a water sample that comprises a metal contaminant with said mat.

20. A method comprising: electrospinning a mixture comprising a carbon source (e.g. PAN), an iron oxide, a poly-carboxylic acid, and a solvent to provide a composite.
